(19) United States
(12) Patent Application Publication
(10) Pub. No.: US 2013/0054375 A1
(43) Pub. Date: Feb. 28, 2013

(54) PERSONALIZED TRAVEL EXPERIENCE WITH SOCIAL MEDIA INTEGRATION

(71) Applicants: Aimee Rowena Sy, Makati (PH); Richard Joseph L. Montero, Makati City (PH); Jemmuel Del Carmen, Cavite (PH); Nino Cayetano Herrera, Marikina City (PH)

(72) Inventors: Aimee Rowena Sy, Makati (PH); Richard Joseph L. Montero, Makati City (PH); Jemmuel Del Carmen, Cavite (PH); Nino Cayetano Herrera, Marikina City (PH)

(73) Assignee: ACCENTURE GLOBAL SERVICES LIMITED

(21) Appl. No.: 13/216,937

(22) Filed: Aug. 24, 2011

(51) Int. Cl. G06Q 30/00

(52) U.S. Cl. 705/14.66

(57) ABSTRACT

Disclosed are systems and methods for providing a personalized travel experience by using information contained on social media sites. The system can analyze a plurality of transit characteristics for available transit. Disclosed embodiments collect and store, from social media sites, preference and profile information of potential customers and their friends, with their permission. The system then analyzes the customer's and the friends' information and develops personalized travel recommendations for the customer. Disclosed embodiments allow the travel system to post information on the customer's social media page, with the customer's permission.

### TECHNICAL FIELD

This invention relates to automated systems and methods for integrating travel experiences and reservation systems with social media.

### BACKGROUND

Travelers, including airline travelers, are increasingly interested in having a personalized travel experience that is tailored to their particular preferences. Some travel reservation systems attempt to provide personalized services to customers by compiling customer information into a Customer Relationship Management (CRM) system.

The existing CRMs rely on historical data analysis of both the customer and passengers. These systems allow customers to enter preference and rating information during the booking process, during travel, or after travel completion. While recommendations for future travel can be based on a customer's preference profile, the associated data that is analyzed must be directly entered into a central database by the customer. Thus, the existing technologies are very limited due to their dependence on the types of questions asked or data that are collected, as well as their dependence on the limited pool of past customers. This makes many of the current technologies inapplicable to various potential customers. In addition, the present CRM systems add inconvenience to the customer by requiring the customer to provide potentially duplicative information that could be obtained elsewhere.

The social media space has revolutionized information distribution by facilitating the passing of viral marketing messages from person to person through the social networking space. Some of the related innovations include promotions, customer service blogs, and advertising and marketing of travel products, including airline products. Although current travel technologies use social media information to advertise and market airline products, these technologies do not personalize the customer's travel experience in any meaningful way.

### SUMMARY

In response to these and other needs, the present disclosure provides a computer-implemented method and related system for providing a personalized traveler experience. In particular, certain embodiments of the disclosure provide a method that can utilize social media sites to obtain preference and/or profile information about a traveler and/or a traveler's friends to develop and offer personalized travel recommendations. The information obtained from the social media sites can relate to various attributes that correspond to potential transit, including destination type, transit-related service, and ancillary service.

In certain embodiments, the method includes obtaining hobbies or likes from a social media site of a traveler and/or a traveler's friend. This information can be processed to offer personalized recommendations to the traveler regarding, for example, destination type, seat preference, nearby seatmates, in-transit meals, baggage requirements, rental car information, hotel information, restaurant information, recreation, information, etc.

Certain other embodiments of the disclosure provide a method for sending travel information related to a traveler to a social media site. This information can include directed travel advertisements, the traveler's travel bookings, the traveler's transit status, transit schedule changes, etc. In particular, this method allows others to view the traveler's social media site to coordinate transit schedules, keep apprised of traveler's whereabouts, etc.

### BRIEF DESCRIPTION OF THE DRAWINGS

A more complete understanding of the disclosed embodiments and advantages thereof may be acquired by referring to the following description taken in conjunction with the accompanying drawings in which like reference numbers indicate like features, wherein:

FIG. 1 is a block diagram depicting an embodiment of a travel service integrated with social media 100.

FIG. 2 is a block diagram displaying a plurality of possible social media providers 150.

FIG. 3 is a block diagram displaying a plurality of possible transit attributes.

FIG. 4 is a block diagram displaying a plurality of possible transit-related services 360.

FIG. 5 is a block diagram displaying a plurality of possible seat preferences 400.

FIG. 6 is a block diagram displaying a plurality of possible ancillary services 320.

FIG. 7 is a flowchart depicting an embodiment of a travel service that integrates social media 700.

FIG. 8 is a block diagram displaying a plurality of possible information types that can be provided to a social media site.

### DETAILED DESCRIPTION

Systems and methods are disclosed for providing a personalized travel experience by utilizing customer information from personal social media sites such as personal media sites, professional media sites, etc. A travel service, with permission from the customer, can interface with social media sites to collect preference and/or profile information about customers and their friends. Such a travel service can be, for example, a CRM system or a proprietary reservation system. Systems and methods are disclosed that are capable of storing and utilizing a customer's information (including, but not limited to, past travel destinations, locations resided, and topics “liked” on a social media site) to determine and offer travel suggestions. In certain embodiments, the system periodically and automatically collects the information from social media sites so that the information is readily available when the customer accesses the travel service.

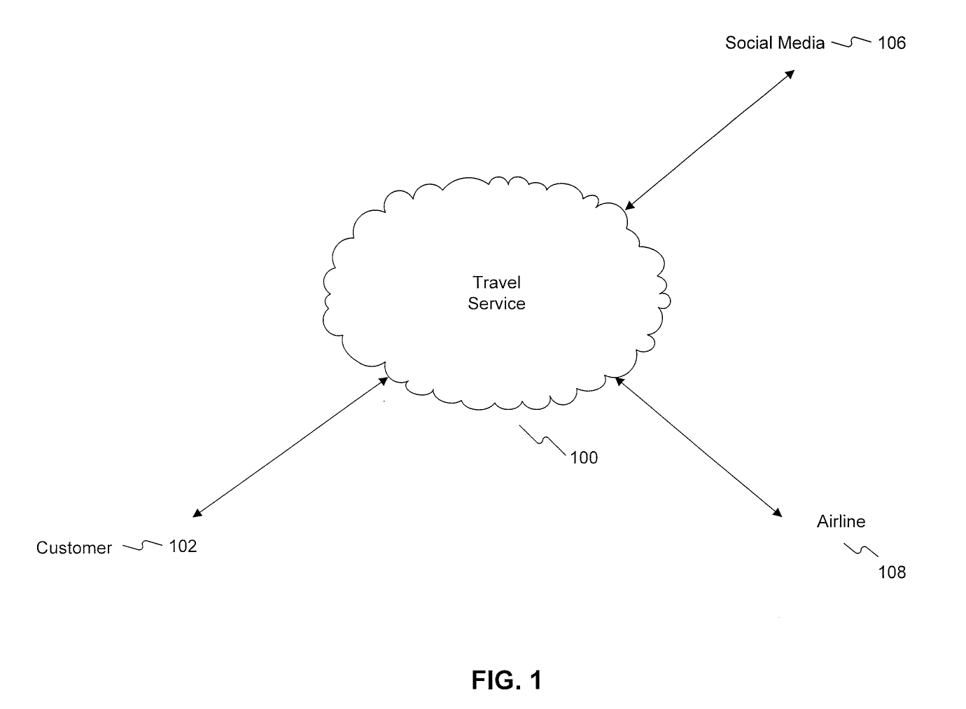

FIG. 1 depicts an embodiment of a travel service 100 that incorporates customer information from social media sites 106. The service 100 can be, for example, a CRM system or proprietary travel reservation system. In the displayed embodiment, the travel service 100 interfaces with a system, such as an airline 108, to determine various flight attributes of available flights. Although this disclosure is often described with regard to airline travel, one of ordinary skill in the art would understand that this disclosure encompasses all types of transit systems, including travel by rail, boat, etc. The travel service also, with the customer's permission, can interface with one or more social media sites 106 to obtain preference and/or profile information of the customer and/or the customer's friends. In one embodiment, the service automatically and periodically collects this updated information so that it is readily available when the customer accesses the travel service 100. After analyzing the customer's information from social media sites 106, the travel service 100 can offer personalized travel suggestions to the customer 102. These suggestions may be valuable and highly personalized because they are based on the customer's preferences as provided by social media 106. In one embodiment, the travel service 100 may send at least some types of personalized suggestions directly to the airline before sending them to the customer 108. In one such embodiment, the airline 108 can monitor, approve, filter, override, or otherwise deal with the potential suggestion before it is communicated to the customer 102.

In certain embodiments, social media information can be used to offer travel suggestions from a trusted source: based on the customer's own preferences, from friends, from the community of airline travelers, from the airlines themselves, etc. The personalized suggestions can include, for example, flight destinations. In certain embodiments, the travel service can recommend flights to locations that the customer or the customer's friends have been to or “liked” on Facebook®. In other examples, travel suggestions may include transit-related services, including but not limited to seat preferences, nearby seatmates, in-transit meal selections, and baggage requirements. In certain embodiments, the travel service can suggest a certain type of in-transit meal based on meals selected or “liked” by the customer or the customer's friends. In another embodiment, the travel service can offer a seat nearby to other passengers that are “friends” on social media sites, who have similar hobbies or occupations, etc. Systems and methods are also disclosed that offer suggestions of ancillary services, including but not limited to rental car information, hotel information, restaurant information, and recreation information. For example, in one embodiment, the travel service can suggest local golf courses for a traveler who lists golf as a hobby on Facebook®.

In some embodiments, with the customer's permission, the system may provide relevant travel information to the passenger's social media site. This type of information may include, for example, the customer's transit status and transit time changes. In this way, the passenger's family, friends, and colleagues may be apprised of the passenger's whereabouts and safety by simply monitoring the passenger's social media site. In some embodiments, the travel service can provide targeted advertisements and promotions on a customer's social media page.

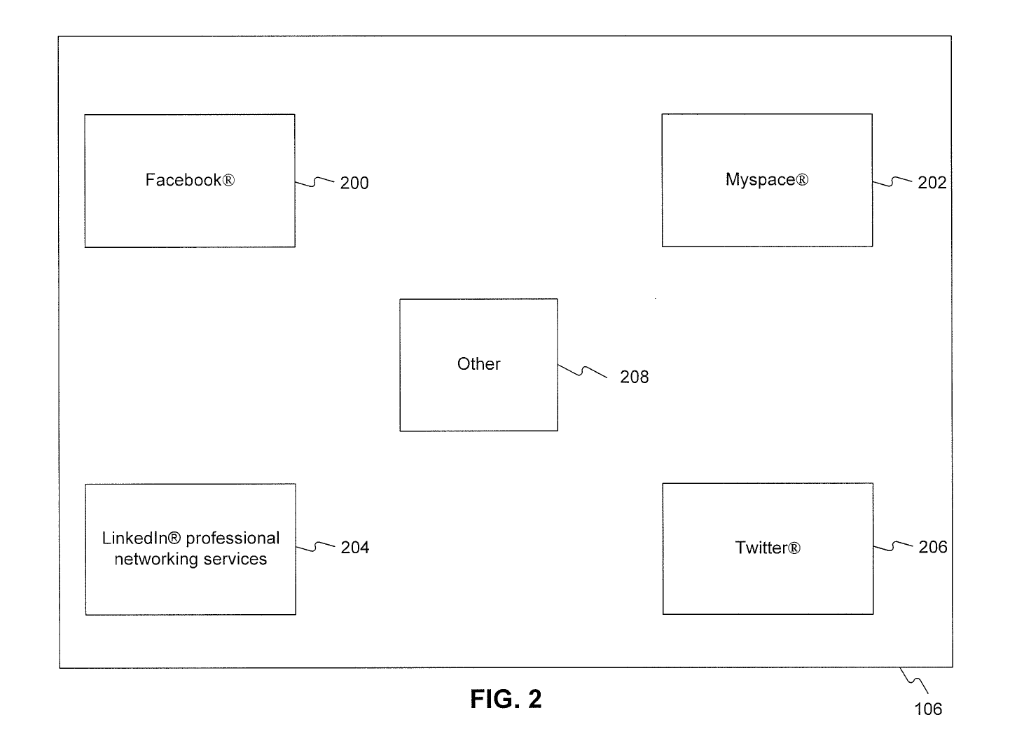

FIG. 2 is a block diagram that depicts possible social media sites 106 that the travel service 100 can interface with to collect information about the customer and/or the customer's friends. These sites may include, for example, Facebook® 200, Myspace® 202, LinkedIn® professional networking services 204, Twitter® 206, etc. These social media sites often contain preference and/or profile information that is relevant to personalized travel suggestions. One of skill in the art would recognize that there are other possible social media avenues in which to obtain preference and/or profile information.

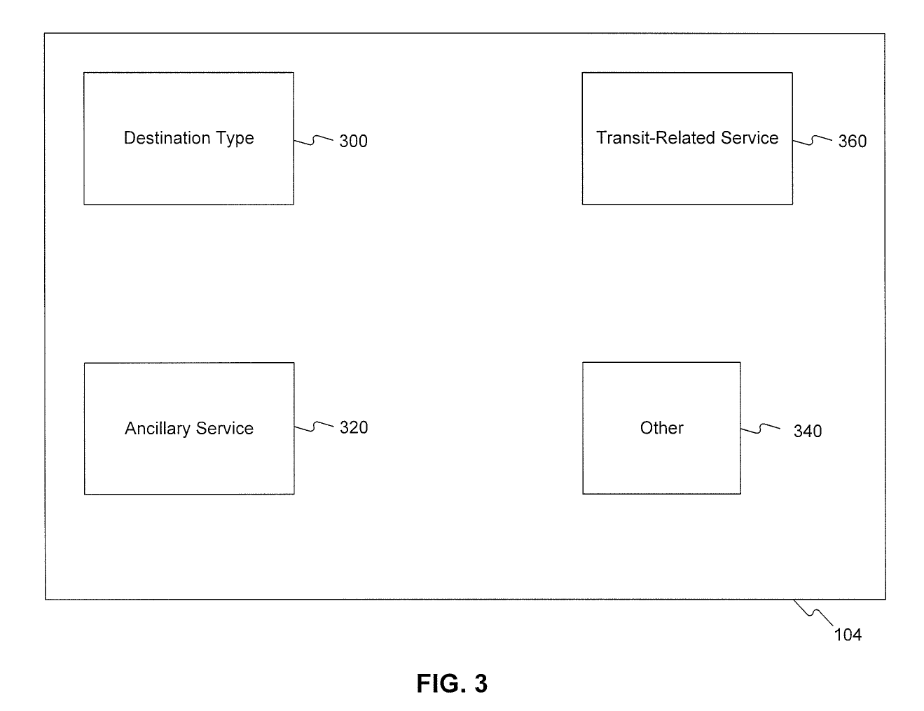

FIG. 3 is a block diagram that depicts possible types of transit attributes that a travel service 100 may obtain from, for example, airline 108. These include, but are not limited to, destination type 300, ancillary service 320, transit-related service 360, and other services 340. A destination type 300 may be, for example, a resort destination, a beach destination, a winter sports destination, etc. If the social media data about customer 102 indicates that they like to ski and airline 108 provides information about a special rate for flights or tickets to a ski destination 300, then the travel service 100 may recommend this special rate to customer 102. In another example, a destination type 300 may be the location where one or more of a customer's friends reside. If the social media data about customer 102 and customer's friends indicate that at least one friend resides in a particular location, then the travel service 100 may recommend this location to customer 102. In another example, a destination type 300 may be a location that one or more of a customer's friends has liked or recommended. If the social media data about customer 102 and customer's friends indicate that at least one friend has liked or recommended a particular location, then the travel service 100 may recommend this location to customer 102.

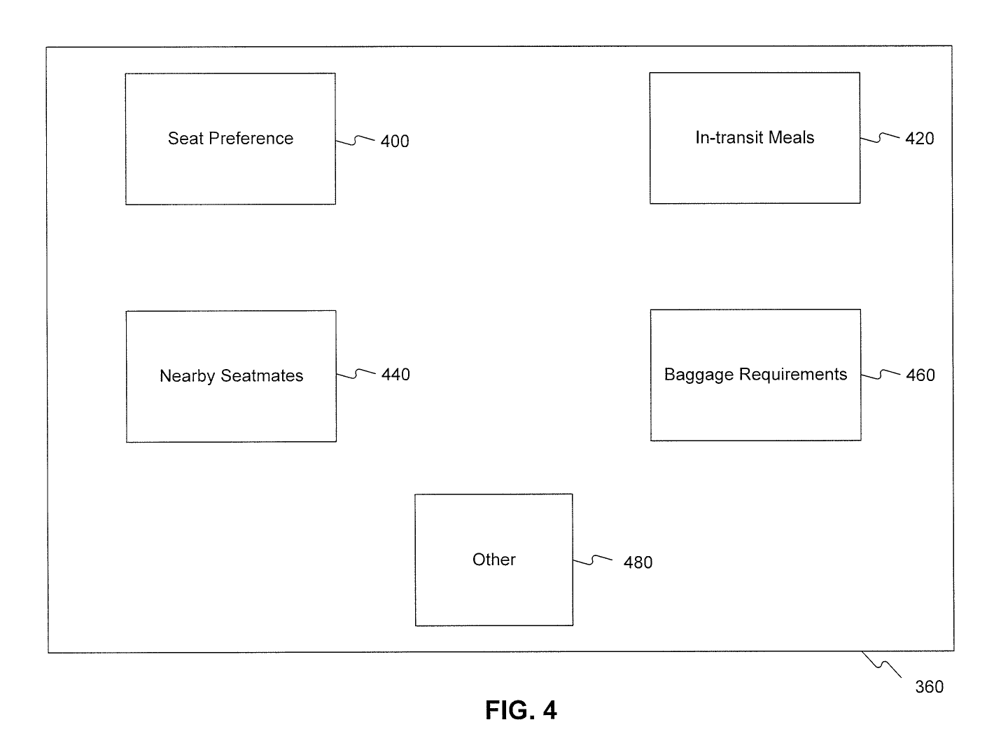

In one embodiment, the travel service 100 determines these attributes as flights become available, and independent of a particular customer 102, so that the flight attribute data is readily available when any customer 102 accesses the travel service 100. Examples of these attributes will now be described in greater detail with reference to FIGS. 4-6.

FIG. 4 is a block diagram that depicts various types of transit-related services 360 that a travel service 100 may recommend based on user preferences. These include, but are not limited to, seat preferences 400, in-transit meals 420, nearby seatmates 440, and baggage requirements 460. An in-transit meal 420 may be, for example, a vegetarian option, an Italian meal, an Asian meal, etc. If the social media data about customer 102 and/or a customer's friends indicates that they like a particular meal type and, for example, airline 108 provides information about in-transit meal options 420, then the travel service 100 may recommend this in-transit meal type to customer 102. For example, if the social media data about customer 102 indicates that they like animal rights organizations and airline 108 provides information about vegetarian meal options 420, then the travel service 100 may recommend this meal type to customer 102.

In another example, nearby seatmates 440 may be, for example, coworkers, friends, people of similar interests, etc. If the social media data about customer 102 indicates their friends, hobbies, place of employment, etc., and airline 108 provides information about other passengers, then the travel service 100 may recommend that traveler choose these other passengers as nearby seatmates 440. Additionally, if the social media data about customer 102 indicates they like to read, like quiet, etc., and airline 108 provides information about other passengers, then the travel service 100 may recommend nearby seatmates 440 that are not children.

Baggage requirements 460 may include, for example, baggage allowances, excess baggage vouchers, excess baggage information, etc. If the social media data about customer 102 indicates that the customer might require excess baggage handling, and airline 108 provides information about baggage requirements and options 460, then the travel service 100 may recommend information, vouchers, deals, etc. regarding baggage requirements 460. As one example, if the social media data about customer 102 indicates they and/or their friends like shopping, are from a region with high shopping volume, like to travel to regions known for shopping, etc., and airline 108 provides information about baggage requirements and options 460, then the travel service 100 may recommend information, vouchers, deals, etc. regarding excess baggage requirements 460.

As an additional example, if the social media data about customer 102 indicates that the customer and/or the customer's friends work in the insurance industry, like an insurance company, etc., and airline 108 provides information about flight insurance 480, then the travel service 100 may recommend to customer 102 information, vouchers, deals, etc. regarding flight insurance 480.

If the social media data about customer 102 indicates that the customer and/or the customer's friends like a particular type of entertainment such as music, movies, television shows etc., and airline 108 provides information about in-flight entertainment 480, then the travel service 100 may recommend to customer 102 flights with the preferred in-flight entertainment, and/or seating preferences 400 with optimal entertainment access.

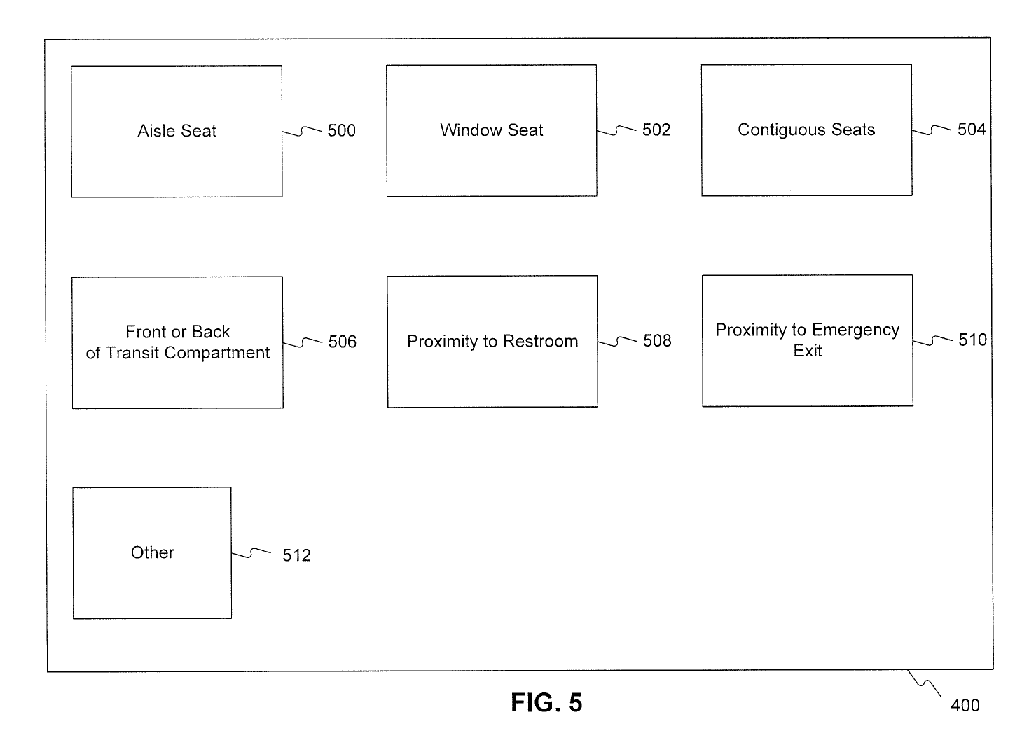

FIG. 5 is a block diagram that depicts possible types of seat preferences 400 that a travel service 100 may recommend based on user preferences. These include, but are not limited to, aisle seats 500, window seats 502, contiguous seats 504, front or back of aircraft 506, proximity to restroom 508, proximity to emergency exit 510, etc. As one example, if the social media data about customer 102 indicates they like the outdoors, photography, mountains, skydiving, etc., and airline 108 provides information about seat preferences 400, then the travel service 100 may recommend a window seat 502 to customer 102. Similarly, if the social media data about customer 102 indicates they dislike heights, and airline 108 provides information about seat preferences 400, then the travel service 100 may recommend an aisle seat 500 to customer 102. In another example, if the social media data about customer 102 indicates they get motion sickness, like certain motion sickness treatments, etc., and airline 108 provides information about seat preferences 400, then the travel service 100 may recommend a seat near the center of gravity of the plane 506. If the social media data about customer 102 indicates they are tall, like basketball, like tall clothing stores, etc., and airline 108 provides information about seat preferences 400, then the travel service 100 may recommend a seat with extra leg room 512 to customer 102.

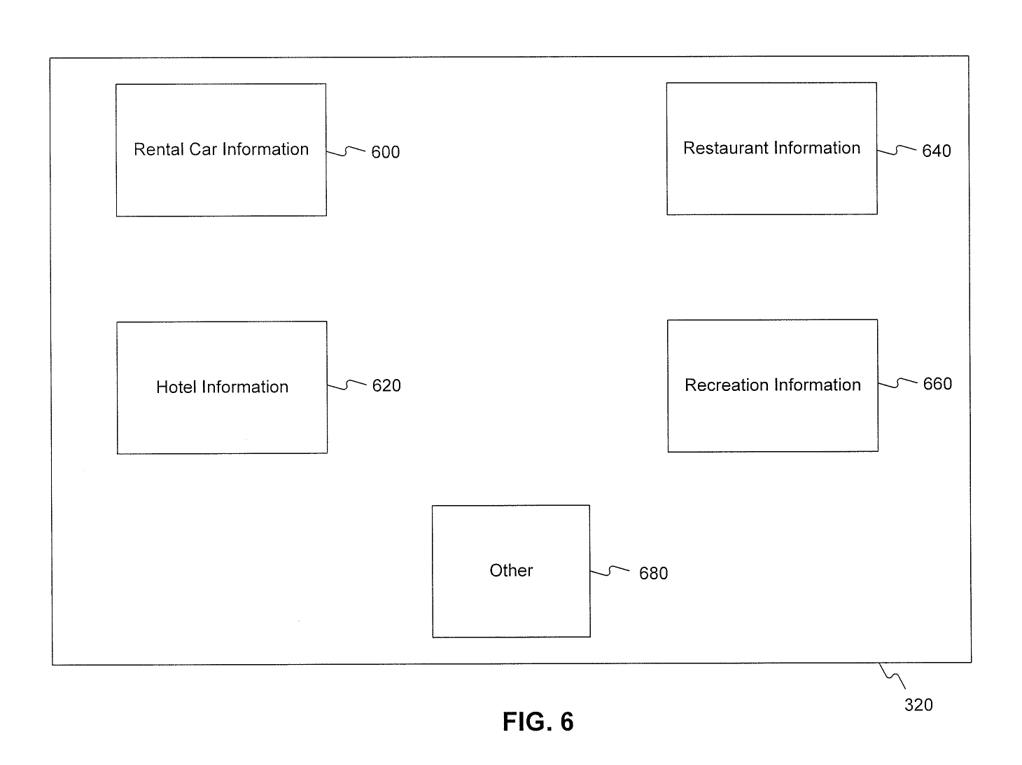

FIG. 6 is a block diagram that depicts possible types of ancillary services 320 that a travel service 100 may recommend based on user preferences. These include, but are not limited to, rental car information 600, hotel information 620, restaurant information 640, and recreation information 660. As an example, if the social media data about customer 102 and/or a customer's friends indicates that they like a particular rental car company, and airline 108 provides information about rental car options 600, then the travel service 100 may recommend this car rental company to customer 102. Similarly, if the social media data about customer 102 and/or a customer's friends indicates that they like a particular make and/or model of car, then the travel service 100 may recommend to customer 102 a car rental company that carries that make and/or model.

As another example, if the social media data about customer 102 indicates that the customer and/or customer's friends enjoy swimming, exercising, gambling, etc., then the travel service 100 may recommend particular hotels 620 with those amenities to customer 102.

Further, if the social media data about customer 102 indicates that the customer and/or customer's friends like a particular restaurant, and airline 108 provides information about restaurants at the destination 640, then the travel service 100 may notify customer 102 of all locations of that particular restaurant in the destination location.

In addition, if the social media data about customer 102 indicates that the customer and/or customer's friends like golf, and airline 108 provides information about recreation at the destination 660, then the travel service 100 may recommend, offer discounts at, etc. various local golf courses to customer 102 at the destination location.

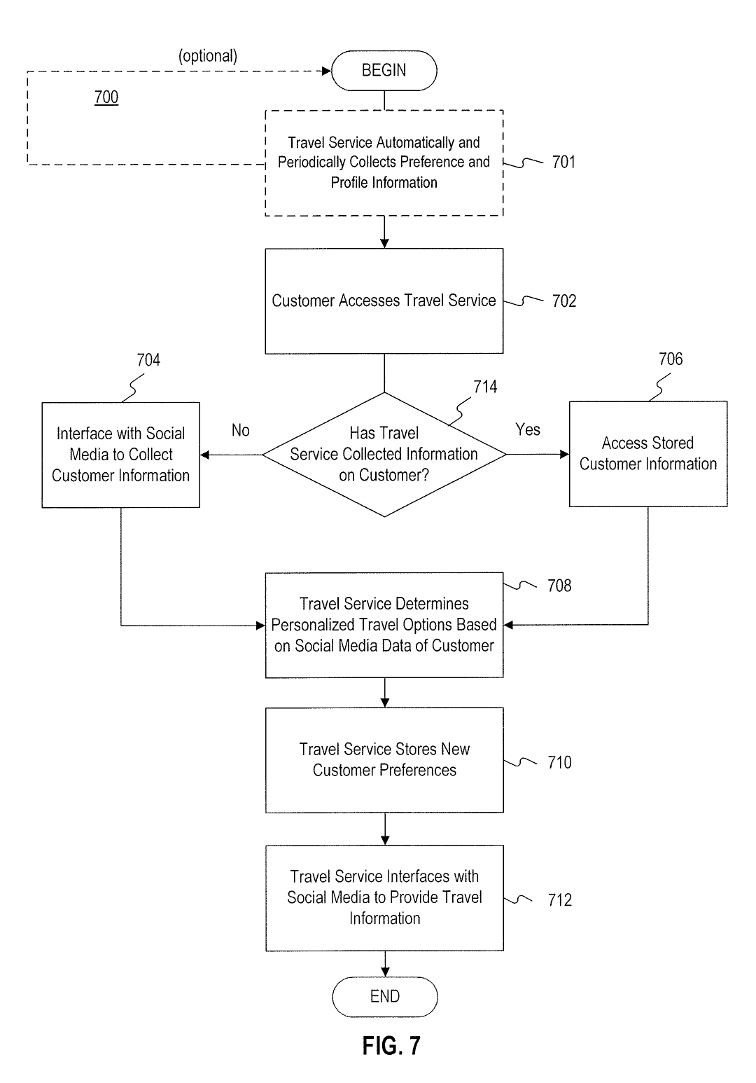

FIG. 7 is a flowchart that depicts a process 700 performed by a travel service 100 that utilizes information on social media sites 106 to offer a personalized travel experience. After receiving permission from customer 102, the travel service 100 may automatically and periodically collect preference and/or profile information from at least one social media site 106 (step 701). One of ordinary skill in the art will understand that the collection of information (step 701) can occur at any time during the process 700. In one embodiment, the collection of information occurs when customer is not actively seeking travel suggestions. In a further embodiment, the collection of information (step 701) occurs multiple times during the process 700 for providing a personalized travel experience. The customer can access the travel service (step 702), for example, by accessing a CRM or other proprietary travel reservation systems. For example, a customer 102 may “opt in” to a social media travel service via an airline's website, a special travel service website, etc. The travel service 100 then determines whether it has obtained information about the customer and/or the customer's friends from social media sites (step 714). This information can include, but is not limited to, place of residence, likes, dislikes, occupation, friends, hobbies, etc. For example, the travel service 100 can obtain data that customer 102 and/or customer's friends like Italian food, skiing, bed and breakfast accommodations, and jazz music. In one embodiment, the travel service periodically and automatically collects and stores preference and/or profile information of registered customers so that it is conveniently accessible, and to avoid repetitive collection of information (step 706). If, however, the customer's information has not yet been obtained and/or recently updated from social media sites, the travel service 100 can search the available social media sites 106 when the customer accesses the travel service (step 704). For example, travel service 100 may determine which social media sites 106 the customer 102 belongs to and obtain profile and/or preference information from one or all of them. This information may include, for example, place of residence, age, number of children, occupation, friends, hobbies, likes, etc. The travel service 100 may then process the social media information of the customer and/or the customer's friends to determine personalized travel options for the customer (step 708).

For example, if the social media data about a customer's friends indicates that at least one of the customer's friends has purchased a flight to a particular destination type 300, and airline 108 provides information about destination type 300, then the travel service 100 may recommend to customer 102 the same destination type 300 as customer's friends. In this way, customer 102 may be given the option of traveling to the same destination type 300 as a friend. Similarly, customer 102 may be given the option to travel to a destination type 300 that at least one friend has frequented in the past.

As another example, if a significant number of the customer's friends enjoy visiting the beach, customer 102 may well travel to beaches to vacation with friends, whether or not customer 102 enjoys beaches. Thus, if the social media data about a customer's friends indicates that they like the beach, and if airline 108 provides information about destination types 300, then the travel service 100 may recommend a flight to a beach destination to customer 102. Additionally, because many friends share at least one common interest or attribute, it may be that customer 102 prefers or would prefer what a trusted friend likes. For example, if a significant number of the customer's friends like jazz music, customer 102 may well also like jazz, whether or not customer 102 included that preference on a social media site. Thus if the social media data about a customer's friends indicates that they like jazz music, and airline 108 provides information about in-transit entertainment options 480, then the travel service 100 may recommend to customer 102 a flight or seat preference 400 in which customer 102 can listen to jazz.

In another embodiment, the travel recommendations to a customer can be based on information obtained from the transit community. For example, this transit community information can be comprised of data regarding all travelers, all travelers of a particular transit company, etc. In this way, recommendations can also be made to customer in the event that neither the customer nor the customer's friends have significant usable data on social media sites.

The recommendations can relate to any of the transit attributes 104 that the travel service analyzes. If a customer makes selections or purchases based on the personalized travel options, this information can also be stored with the customer's preference and profile data (step 710). In one embodiment, the travel service 100 may send the travel recommendations to the airline 108 for approval before providing it to the customer. In this way, the airline can assure that all recommendations are correct, relevant, and available. For example, seat availability may be constantly changing. Thus it may be advantageous for the airline 108 to double check the current availability of, for example, contiguous seats 504, aisle seats 500, window seats 502, etc., before offering any of those options to customer 102. A person of skill in the art will recognize that this step may not be necessary if all availabilities are on a real-time reservation system.

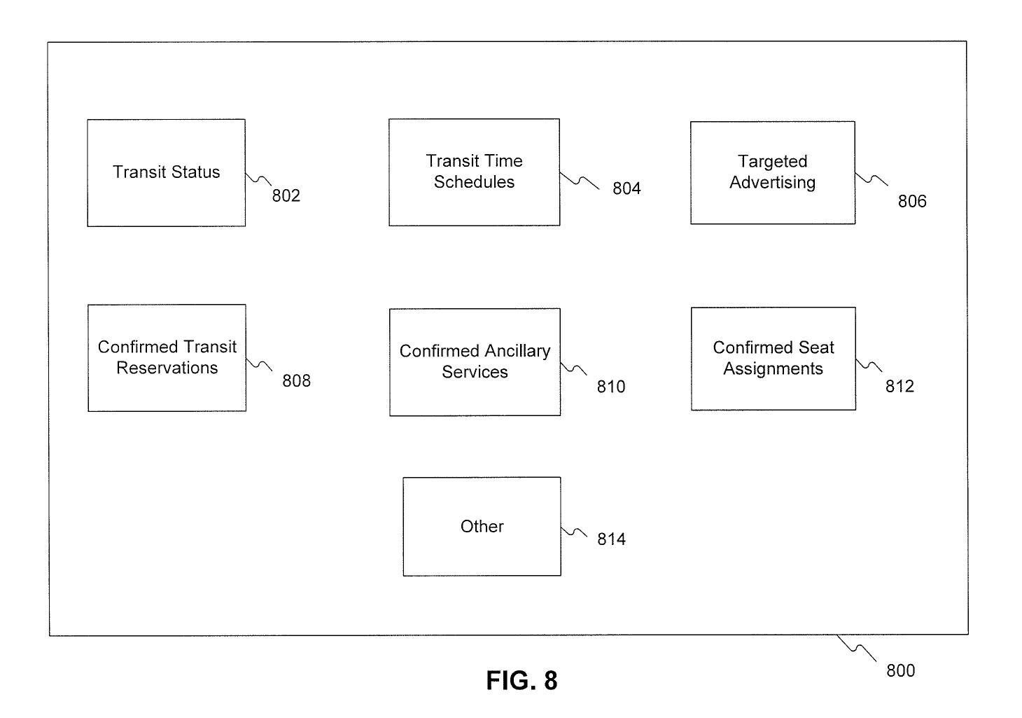

In one embodiment, the travel service can also push information back to the social media site (step 712). FIG. 8 shows a variety of types of information that can be sent to a social media site. This information can include, but is not limited to, the customer's current transit status 802 and time schedule 804. In this way, others can easily determine the customer's location and availability by simply checking the customer's social media page. This information can further include customer's 102 confirmed transit reservations 808, confirmed ancillary services 810, confirmed seat assignments 812, etc. Thus, merely by reviewing at least one social media site 106, friends and observers are able to select, coordinate, alter, etc. their own travel plans to be consistent with customer's 102.

In addition, the travel service can post targeted advertising to the customer's social media page 806. By doing so, the transit company, such as an airline company, is able to offer promotions and deals that the customer and/or the customer's friends may find relevant.

A number of embodiments of the invention have been described. Nevertheless, it will be understood that various modifications may be made without departing from the spirit and scope of the invention. Although this disclosure is often described using the airline embodiment, one of ordinary skill in the art recognizes that this disclosure encompasses all transit systems and/or forms of transit (e.g., trains, buses, taxis, boats, etc.).

What is claimed is:

1. A computer-implemented method for providing a personalized traveler experience, comprising:
determining attributes corresponding to potential transit, wherein the attributes include at least one of destination type, transit-related service, and ancillary service;
obtaining traveler information related to a traveler from a social media site, wherein the traveler information includes at least one of the following:
profile information associated with the traveler, and
preference information associated with the traveler;
obtaining friend-related information related to at least one friend of the traveler from a social media site, wherein the friend-related information includes at least one of the following:
profile information associated with at least one friend, and
preference information associated with at least one friend;
processing the traveler information and friend-related information to develop one or more personalized recommendations for the traveler based on the attributes corresponding to potential transit; and
presenting the one or more travel recommendations to the traveler.

2. The method of claim A1, wherein the processing is further based on transit community information.

3. The method of claim A1, wherein the transit-related service includes at least one of:
seat preference,
nearby seatmates,
in-transit meals, and
baggage requirements.

4. The method of claim A1, wherein the ancillary service includes at least one of:
rental car information,
hotel information,
restaurant information, and
recreation information.

5. The method of claim A1, further comprising:
sending travel information related to the traveler to a social media site, wherein travel information includes at least one of:
directed travel advertisement,
the traveler's transit booking,
the traveler's transit status, and
transit schedule changes.

6. The method of claim A1, further comprising:
presenting the one or more travel recommendations to a transit system associated with the potential transit.

7. The method of claim A1 wherein the processing further comprises:
determining a preferred location type from the profile information associated with the traveler;
matching a location in the profile information associated with the at least one friend to the preferred location type; and
identifying the matching location as the travel recommendation for the traveler.

8. The method of claim A1 wherein the processing further comprises:
determining at least one preferred hobby or like from the preference information associated with the traveler;
matching at least one hobby or like in the preference information associated with the at least one friend to the preferred hobby or like of the traveler; and
identifying a travel destination as the travel recommendation for the traveler based on the matching hobby or like.

9. The method of claim A1 wherein the processing further comprises:
determining at least one preferred hobby or like from the preference information associated with the traveler;
matching at least one hobby or like in the preference information associated with the at least one friend to the preferred hobby or like of the traveler; and
identifying a seating preference as the travel recommendation for the traveler based on the matching hobby or like.

10. The method of claim A1 wherein the processing further comprises:
determining at least one preferred hobby or like from the preference information associated with the traveler;
matching at least one hobby or like in the preference information associated with the at least one friend to the preferred hobby or like of the traveler; and
identifying travel accommodations as the travel recommendation for the traveler based on the matching hobby or like.

11. A computer system for providing a personalized traveler experience, comprising:
a memory; and
a processor coupled to the memory, the processor being configured to:
determine attributes corresponding to potential transit, wherein the attributes include at least one of destination type, transit-related service, and ancillary service;
obtain traveler information related to a traveler from a social media site, wherein the traveler information includes at least one of the following: profile information associated with the traveler, and preference information associated with the traveler;
obtain friend-related information related to at least one friend of the traveler from a social media site, wherein the friend-related information includes at least one of the following: profile information associated with at least one friend, and preference information associated with at least one friend;
process the traveler information and friend-related information to develop one or more personalized recommendations for the traveler based on the attributes corresponding to potential transit; and
present the one or more travel recommendations to the traveler.

12. The system of claim B1, wherein the processor is further configured to process the information based on transit community information.

13. The system of claim B1, wherein the transit-related service includes at least one of:
seat preference,
nearby seatmates,
in-transit meals, and
baggage requirements.

14. The system of claim B1, wherein the ancillary service includes at least one of:
rental car information,
hotel information,
restaurant information, and
recreation information.

15. The system of claim B1, the processor being further configured to send travel information to a social media site, wherein travel information includes at least one of:
directed travel advertisement,
the traveler's transit bookings,
the traveler's transit status, and
transit schedule changes.

16. The system of claim B1, the processor being further configured to present the one or more travel recommendations to a transit system associated with the potential transit.

17. The system of claim B1, the processor being further configured to:
determine a preferred location type from the profile information associated with the traveler;
match a location in the profile information associated with the at least one friend to the preferred location type; and
identify the matching location as the travel recommendation for the traveler.

18. The system of claim B1, the processor being further configured to:
determine at least one preferred hobby or like from the preference information associated with the traveler;
match at least one hobby or like in the preference information associated with the at least one friend to the preferred hobby or like of the traveler; and
identify a travel destination as the travel recommendation for the traveler based on the matching hobby or like.

19. The system of claim B1, the processor being further configured to:
determine at least one preferred hobby or like from the preference information associated with the traveler;
match at least one hobby or like in the preference information associated with the at least one friend to the preferred hobby or like of the traveler; and
identify a seating preference as the travel recommendation for the traveler based on the matching hobby or like.

20. The system of claim B1, the processor being further configured to:
determine at least one preferred hobby or like from the preference information associated with the traveler;
match at least one hobby or like in the preference information associated with the at least one friend to the preferred hobby or like of the traveler; and
identify hotel accommodations as the travel recommendation for the traveler based on the matching hobby or like.

21. A non-transitory computer-readable storage medium containing instructions which, when executed on a processor, perform a method for providing a personalized traveler experience, the method comprising:
determining attributes corresponding to potential transit, wherein the attributes include at least one of destination type, transit-related service, and ancillary service;
obtaining traveler information related to a traveler from a social media site, wherein the traveler information includes at least one of the following:
profile information associated with the traveler, and
preference information associated with the traveler;
obtaining friend-related information related to at least one friend of the traveler from a social media site, wherein the friend-related information includes at least one of the following:
profile information associated with at least one friend, and
preference information associated with at least one friend;
processing the traveler information and friend-related information to develop one or more personalized recommendations for the traveler based on the attributes corresponding to potential transit; and
presenting the one or more travel recommendations to the traveler.
